(19) United States
(12) Patent Application Publication
(10) Pub. No.: US 2015/0018477 A1
(43) Pub. Date: Jan. 15, 2015

(54) POLYCARBONATE RESIN COMPOSITION FOR VEHICLE EXTERIOR

(71) Applicants: Cheil Industries Inc., Gumi-si (KR); Hyundai Motor Company, Seoul (KR)

(72) Inventors: Hee-Joon LEE, Seoul (KR); Sang-Sun Park, Anyang-si (KR); Jun-Ho Chi, Euilwang-si (KR); Hyun-Jung Cho, Euilwang-si (KR); Jong-Chan Hur, Euilwang-si (KR)

(73) Assignees: Cheil Industries Inc., Gumi-si (KR); Hyundai Motor Company, Seoul (KR)

(21) Appl. No.: 14/135,502

(22) Filed: Dec. 19, 2013

(30) Foreign Application Priority Data
Jul. 12, 2013 (KR) 10-2013-0081940

(51) Int. Cl. C08L 69/00; B29C 45/00; B29B 9/00

(52) U.S. Cl. CPC C08L 69/00; B29B 9/00; B29C 45/00
USPC 524/506; 525/106; 264/211.12

(57) ABSTRACT

A polycarbonate resin composition for a vehicle exterior may include a polycarbonate resin, a silicone polycarbonate, and a syndiotactic polystyrene. The polycarbonate resin may be 45˜85% by weight, the silicone polycarbonate may 10˜50% by weight, and the syndiotactic polystyrene may be greater than 2% by weight and less than 7% by weight, with respect to a total weight of the composition. The polycarbonate resin composition may further include other additives such as a black pigment. The polycarbonate resin composition provides improved physical and/or chemical properties.

### CROSS-REFERENCE TO RELATED APPLICATION

The present application claims priority of Korean Patent Application Number 10-2013-0081940 filed on Jul. 12, 2013, the entire contents of which application are incorporated herein for all purposes by this reference.

### BACKGROUND OF INVENTION

1. Field of Invention

The present disclosure relates to a polycarbonate resin composition for a vehicle exterior. More particularly, it relates to a polycarbonate resin composition for a vehicle exterior, which can replace a fixed window glass of a conventional panorama sunroof, by comprising a polycarbonate resin, and the like.

2. Description of Related Art

Recently, in a vehicle a sunroof is installed on a roof panel for a bright vehicle interior, efficient interior ventilation, cool openness and excellent designing aesthetic sensibility. Also, a panorama sunroof is gaining popularity because most of the roof panels are fabricated from glass and thus the openness is maximized so as to create a convertible atmosphere.

The panorama sunroof has a structure in that most of the roof panels of the vehicle are covered with glass, upon opening the glass, the roof is widely opened so that a cool driving feeling can be felt. This panoramic glass sunroof is classified as a two-piece type, three-piece type, etc. depending on the number of the pieces of glass being applied.

In particular, in the case of the three-piece type of panorama sunroof, there is a disadvantage in that although the glass of the first front edge of the vehicle is not necessarily transparent, an unnecessary weight increase and a degree of freedom of design are limited because glass is used simply to impart a sense of unity between a windshield glass and the rest moving- and fixed-window glasses for sunroof.

In order to overcome said disadvantage, the present invention intends to apply the polycarbonate resin composition instead of the glass of the first front edge of the panorama sunroof. Since the polycarbonate resin has excellent impact resistance and heat resistance, etc. and is transparent, it is an engineering plastic which is advantageous for embodying a deep black feeling which is similar to glass.

However, since the polycarbonate resin has a relatively high line expansion coefficient, there are disadvantages in that interference with a surrounding part may be occurred, and an impact resistance, low-temperature impact property and chemical resistance are also weak.

In order to improve the chemical resistance among said disadvantages, U.S. Pat. No. 4,740,553 discloses a technique for improving a chemical resistance by adding a polymer, consisting of an acrylate monomer, to a polycarbonate resin and styrene-based resin comprising an elastomer. However, there is a problem that an excellent impact resistance which is an advantage of polycarbonate can be decreased although the chemical resistance of polycarbonate can be improved.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to solve at least some of the above-described problems associated with the prior art. The purpose of the present invention is to solve said problems by providing a polycarbonate resin composition for a vehicle exterior, having an excellent physical property while embodying a high glossy black feeling similar to glass, by comprising a polycarbonate resin, silicone polycarbonate and syndiotactic polystyrene, and the like.

In order to achieve said purpose and/or other purposes, the polycarbonate resin composition for a vehicle exterior is characterized by comprising a polycarbonate resin, silicone polycarbonate and syndiotactic polystyrene, and the like.

Also, in some aspects of the present invention, it is preferable that the polycarbonate resin is 45˜85% by weight, the silicone polycarbonate is 10˜50% by weight, and the syndiotactic polystyrene is greater than 2% by weight and less than 7% by weight with respect to the total weight of the composition. In some aspects of the present invention, it is preferable that said composition further comprises a black pigment. In one aspect of the present invention, it is preferable that the polycarbonate resin is about 65% by weight, the silicone polycarbonate is about 30% by weight, and the sydiotactic polystyrene is about 5% by weight.

In addition, the present invention provides a polycarbonate resin molded product for a vehicle exterior, prepared from said composition.

Further, a method for producing a polycarbonate resin molded product for a vehicle exterior may include: preparing a mixture that includes polycarbonate resin, silicone polycarbonate, syndiotactic polystyrene, antioxidant, and phosphorus-based heat stabilizer; extruding said mixture with a biaxial extruder to produce a pellet; and drying and then injecting said pellet to produce the molded product.

The present invention having said constitution has advantages that it can embody a high glossy black feeling similar to glass by comprising a polycarbonate resin and black pigment, and the like, and that it has a good dimensional stability and change in response to temperature variation is small and thus reduces or prevents a gap with surrounding parts.

In addition, the present invention has advantages in that it is not easily fractured by an external impact since the impact strength, impact resistance and low-temperature impact property are excellent, and has an excellent effect in that resistance to various chemicals is excellent because of the good chemical resistance.

Further, the present invention has advantages in that a weight reduction to the level of 30˜40% compared to conventional glass is possible, and a various design realization is possible since the moldability is excellent compared to conventional glass.

### DETAILED DESCRIPTION

The terms or words used in the specification and the claims of the present application should not be interpreted as being limited to a conventional or dictionary meaning, and should be interpreted as the meaning and concept that accord with the technical spirit on the grounds of the principle that the inventor can appropriately define the concept of the term in order to explain his invention in the best way.

Reference will now be made in detail to various embodiments of the present invention(s), examples of which are illustrated in the Tables and are described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The present invention relates to a polycarbonate resin composition for a vehicle exterior. The present invention comprises a polycarbonate resin, silicone polycarbonate and syndiotactic polystyrene, etc. with respect to the total weight of the composition. Also, the present invention can further comprise additives such as a pigment, etc., and in various embodiments, it is preferable that said pigment is black to realize a deep high glossy opaque black feeling, and the like.

Hereinafter, each of the constitutional components and the contents thereof to be contained in the present invention are illustrated.

### 1. The Constitutional Components of the Present Invention

### 1.1 Polycarbonate Resin

The polycarbonate resin is a thermoplastic resin prepared by reacting a bisphenol A and phosgene, and the like. The polycarbonate resin has a high mechanical strength and good impact resistance to the extent that it has a strength of more than about 250-fold of that of plate glass and more than about 30-fold of acryl. Also, a physical property of the resin according to the temperature variation is stable, dimensional stability is good since dimension change is very small due to moisture absorption, and weather resistance is excellent. Also, there are advantages in that since the polycarbonate is able to be easily bent, unlike glass, it can be easily prepared in various forms, and since it is non-crystalline, the permeability to visible light is high, and it is transparent like glass.

In some embodiments of the present invention, the average molecular weight of said polycarbonate resin is preferably from 20,000 g/mol to 30,000 g/mol, more preferably 25,000 g/mol. At this time, if the average molecular weight is less than 20,000 g/mol, the impact resistance is reduced and the processability can be reduced due to an excess increase of flowability, and if the average molecular weight is greater than 30,000 g/mol, the processability can be reduced due to the decrease of the flowability.

In addition, in some embodiments, the polycarbonate is preferably 45˜85% by weight, with respect to the total weight of the composition, and is more preferably 65% or about 65% by weight. At this time, if the polycarbonate is less than 45% by weight, the physical property such as an impact resistance, etc. of the composition can be reduced, and if it is greater than 85% by weight, the interference with the surrounding parts due to large line expansion coefficient can occur, and weather resistance can be reduced.

Further, in order to improve the flowability of the composition upon molding, two or more of polycarbonates resins having a different average molecular weight can be mixed and used.

Furthermore, said polycarbonate resin can be selected from the group consisting of a linear polycarbonate resin, branched polycarbonate resin, polyester carbonate copolymer, and the like.

### 1.2. Silicone Polycarbonate (Si-PC)

The silicone polycarbonate is a silicone compound contained in a polycarbonate and it can be prepared by reacting a mixture of bisphenols such as bisphenol and bisphenol A, etc., wherein siloxane is contained with an aqueous solution wherein an acid receptor such as phosgene and aqueous sodium hydroxide solution are contained, under the presence of an surfactant. Also, the silicone polycarbonate is added in order to improve the physical properties such as a low-temperature impact strength, chemical resistance, flame resistance, etc. of the polycarbonate resin composition.

Further, in some embodiments, the silicone polycarbonate is preferably 10˜50% by weight with respect to the total weight of the composition, and more preferably 30% or about 30% by weight. At this time, if the silicone polycarbonate is less than 10% by weight, the low-temperature impact strength of the composition may be rapidly reduced, and if it is greater than 50% by weight, the transparency of the composition may be reduced.

### 1.3. Syndiotactic Polystyrene

Polystyrene is classified into atactic, isotactic and syndiotactic structures according to the position of a benzene ring attached to a main chain. The atactic polystyrene has a structure that a benzene ring is randomly arranged to the main chain, and the isotactic polystyrene has a structure that a benzene ring is arranged only one side of the main chain. On the other hand, the syndiotactic polystyrene has a structure that a benzene ring is alternatively arranged on both sides of the main chain. In particular, the syndiotactic polystyrene can be prepared using a catalyst system consisted of a metallocene catalyst and a cocatalyst, etc. from a styrene monomer.

The syndiotactic structure has a high stereoregularity, wherein in some embodiments, a syndiotacticity thereof is preferably 97% or more, and if the syndiotacticity is less than 97%, the chemical resistance of the composition can be reduced. Also, in some embodiments, the syndiotactic polystyrene is preferably greater than 2% by weight and less than 7% by weight, and more preferably 5% or about 5% by weight, with respect to the total weight of the composition. At this time, if the syndiotactic polystyrene is 2% by weight or less, the chemical resistance of the composition can be reduced, and if it is 7% by weight or more, the transparency of the composition can be rapidly reduced.

### 1.4. Additives

In various embodiments, the polycarbonate resin composition can further comprise an antioxidant, heat stabilizer, etc., and it is preferable to further comprise a pigment. In particular, in some embodiments, it is preferable that said pigment is black in order to realize a deep high glossy opaque black feeling, etc.

### 2. Use

Since a polycarbonate resin composition for a vehicle exterior according to the present invention is transparent like glass and has excellent impact resistance and heat resistance, it can be widely applied in molding various articles requiring a high glossy like glass. In particular, it is preferable to be applied to a vehicle exterior, etc., and since it is advantageous to realize a deep black feeling, it is more preferable to apply to a panorama sunroof of vehicle, etc.

### 3. Preparation Method

Polycarbonate resin composition for a vehicle exterior according to the present invention can be appropriately prepared by various methods including conventional methods. Specifically, various constitutional components including additives, such as a polycarbonate resin, etc., can be included in the resin composition, and this composition is prepared so as to contain 45˜85% by weight of the polycarbonate resin; 10˜50% by weight of the silicone polycarbonate; and greater than 2% by weight and less than 7% by weight of the syndiotactic polystyrene, etc. in order to embody the constitutional characteristics as mentioned above.

According to another embodiment of the present invention, a molded product prepared by molding the above-mentioned polycarbonate resin composition is provided. Also, a method for preparing said molded product comprises a first step of mixing a polycarbonate resin, silicone polycarbonate, syndiotactic polystyrene, antioxidant and phosphorus-based heat stabilizer, etc. to prepare a mixture; a second step of extruding said mixture with a biaxial extruder to prepare a pellet; and a third step of drying and then injecting said pellet to prepare a molded product, and the like.

Hereinafter, the present invention will be illustrated in detail by means of Examples. It is self-evident to those having ordinary knowledge in the art that these Examples are only to exemplify the present invention, and the scope of the present invention is not construed as being limited by these Examples.

### EXAMPLE

In order to investigate physical properties such as the impact strength, permeability, dimensional stability, impact resistance and low-temperature impact property, etc. of the polycarbonate resin composition according to the present invention, specimens having constitutional components and contents such as those shown in Table 1 below were prepared and the physical properties thereof were measured, and then compared in Table 2 as below.

TABLE 1

| section | | | | | | Comparative | Comparative | Comparative | Comparative | Comparative |
|---|---|---|---|---|---|---|---|---|---|---|
| (unit: wt %) | Ex. 1 | Ex. 2 | Ex. 3 | Ex. 4 | Ex. 5 | Ex. 1 | Ex. 2 | Ex. 3 | Ex. 4 | Ex. 5 |
| Polycarbonate | 85 | 75 | 65 | 55 | 45 | 100 | 70 | 95 | 68 | 63 |
| resin | | | | | | | | | | |
| Si-PC | 10 | 20 | 30 | 40 | 50 | 0 | 30 | 0 | 30 | 30 |
| Syndiotactic | 5 | 5 | 5 | 5 | 5 | 0 | 0 | 5 | 2 | 7 |
| Polystyrene | | | | | | | | | | |

Table 1 is the table that compares the constitutional components of the specimens to measure physical properties such as an impact strength, permeability, dimensional stability, impact resistance and low-temperature impact property, and the like. In order to prepare said specimens, a polycarbonate resin, silicone polycarbonate and syndiotactic polystyrene relative to the total weight of the composition are mixed in the ratios given in said Tables, respectively, and 0.03 phr (parts per hundred rubber) of an antioxidant and 0.05 phr of a phosphorus-based heat stabilizer, etc. are added and then extruded via a biaxial extruder to prepare a pellet. The pellet prepared above is dried at about 110° C. for 3 hours or more, and then injected at a temperature of about 300° C. to prepare a specimen.

Also, the polycarbonate resin applied to said Examples and Comparative Examples was a bisphenol A type of a polycarbonate resin having an average molecular weight of 25,000 g/mol and the polycarbonate resin used was INFINO SC-1100UR of Cheil Industries Inc. in Korea, the silicone polycarbonate resin used was RC-1700 of IDEMITSU Co., Ltd. in Japan, and the syndiotactic polystyrene used was Zarex 130ZC.

TABLE 2

| | | | | | | | Comparative | Comparative | Comparative | Comparative | Comparative |
|---|---|---|---|---|---|---|---|---|---|---|---|
| Section | | Ex. 1 | Ex. 2 | Ex. 3 | Ex. 4 | Ex. 5 | Ex. 1 | Ex. 2 | Ex. 3 | Ex. 4 | Ex. 5 |
| Izod impact | | 49 | 52 | 55 | 57 | 58 | 12 | 23 | 13 | 23 | 53 |
| strength (¼″) | | | | | | | | | | | |
| Permeability (%) | | 89 | 89 | 89 | 87 | 85 | 89 | 89 | 89 | 89 | 66 |
| Dimension | 90° C. | 1.6 | 1.8 | 2 | 2.3 | 2.7 | 3.2 | 3.5 | 1.4 | — | — |
| change | −40° C. | −3 | −3.1 | −3.2 | −3.4 | −3.5 | −4.2 | −4.4 | −2.8 | — | — |
| (mm) | | | | | | | | | | | |

| | | | | | | | | | | |
|---|---|---|---|---|---|---|---|---|---|---|
| Impact resistance | OK | OK | OK | OK | OK | NG | OK | NG | — | — |
| Low-temperature | OK | OK | OK | OK | OK | NG | OK | NG | — | — |
| impact property | | | | | | | | | | |

OK: Not occurring Crack
NG: Occurring Crack

Table 2 lists measurement results and compares the compact strength, permeability, dimension stability, impact resistance and low-temperature impact property of the specimens prepared with the constitutional components and contents of said Table 1. In order to accurately ascertain actual performance of Examples and Comparative Examples, the physical properties were compared by measuring them under the state that the specimen molded using the composition according to the present invention was assembled to the actual part.

The impact strength was compared by measuring ¼″ (6.35 mm)-thickness of specimen via Izod impact tester in accordance with ASTM D256.

The permeability was compared by measuring the permeability of 2mm-thickness of a specimen by using Haze Meter (trade name: YDP02-0D) of NIPPON DENSHOKU Co., Ltd.

The dimensional stability was compared by repeating three times the steps of maintaining the specimen at 90° C. for 3 hours, maintaining it at room temperature for 1 hour, maintaining it at −40° C. for 3 hours, maintaining it at room temperature for 1 hour, maintaining it at 50° C. and 90% humidity for 7 hours and then maintaining it for 1 hour, and then measuring the dimension change at the high temperature (90° C.) and the dimensional change at the low temperature (−40° C.).

The impact resistance was compared by ascertaining the presence or absence of crack occurrence on a panorama sunroof being a specimen after dropping a 2 kg weight on said specimen placed on a flat floor at the height of 0.5 m.

The low-temperature impact property was compared by ascertaining the presence or absence of crack occurrence on a panorama sunroof being a specimen after dropping a 2 kg weight on said panorama sunroof placed on a flat floor at the height of 0.5 m after aging it at −40° C. for 3 hours.

From said test results of the Examples and Comparative Examples, it can be ascertained that in the case of the impact strength, the Examples are improved by about 3.3 times in average compared to the Comparative Examples, and since the amount of the dimensional change at the high- and low-temperature is within 4 mm being a standard range, the dimensional stability is relatively better. Also, in the case of the impact resistance and low-temperature impact property, crack does not occur in all the Examples but does occur in some of the Comparative Examples. Thus, it can be ascertained that the impact resistance and low-temperature impact property of the Examples are improved in general over those of the Comparative Examples.

Meanwhile, although the amount of the dimensional change of the Comparative Example 3 at the high- and low-temperatures is relatively smaller, the impact strength, impact resistance and low-temperature impact property of this Comparative Example 3 are very weak. In addition, since the Comparative Example 4 has very low chemical resistance and Comparative Example 5 has very low permeability, investigations for additional dimensional stability, impact resistance and low-temperature impact property of these two Comparative Examples were not done.

On the other hand, the Examples according to the present invention have improved physical properties such as impact strength, impact resistance, low-temperature impact property, etc. compared to those of the Comparative Examples; in particular the physical properties of Example 3 are the most improved. Therefore, it can ascertain that the polycarbonate resin composition according to the present invention is suitable and preferable to be applied to the exterior of the vehicle.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A polycarbonate resin composition for a vehicle exterior, comprising:
a polycarbonate resin;
a silicone polycarbonate; and
a syndiotactic polystyrene.

2. The polycarbonate resin composition for a vehicle exterior according to claim 1, wherein said polycarbonate resin is 45˜85% by weight, said silicone polycarbonate is 10˜50% by weight, and said syndiotactic polystyrene is greater than 2% by weight and less than 7% by weight, with respect to a total weight of the composition.

3. The polycarbonate resin composition for a vehicle exterior according to claim 1, further comprising a black pigment.

4. The polycarbonate resin composition for a vehicle exterior according to claim 2, wherein said polycarbonate resin is about 65% by weight, said silicone polycarbonate is about 30% by weight, and said syndiotactic polystyrene is about 5% by weight.

5. A polycarbonate resin molded product for a vehicle exterior, which is prepared from said composition according to claim 1.

6. A method for producing a polycarbonate resin molded product for a vehicle exterior, the method comprising:
preparing a mixture that includes polycarbonate resin, silicone polycarbonate, syndiotactic polystyrene, antioxidant, and phosphorus-based heat stabilizer;
extruding said mixture with a biaxial extruder to produce a pellet; and
drying and then injecting said pellet to produce the molded product.

7. A polycarbonate resin molded product for a vehicle exterior, which is prepared from said composition according to claim 2.

8. A polycarbonate resin molded product for a vehicle exterior, which is prepared from said composition according to claim 3.

9. A polycarbonate resin molded product for a vehicle exterior, which is prepared from said composition according to claim 4.
